(19) United States
(12) Patent Application Publication
(10) Pub. No.: US 2004/0011149 A1
(43) Pub. Date: Jan. 22, 2004

(54) Integrated angular and radial position sensor

(76) Inventor: David Carroll, Strafford, NH (US)

Correspondence Address: Grossman Tucker Perreault & Pfleger, PLLC, 55 South Commercial Street, Manchester, NH, 03101, US

(21) Appl. No.: 10/405,126

(22) Filed: Apr. 2, 2003

Related U.S. Application Data
(60) Provisional application No. 60/369,931, filed on Apr. 3, 2002.

(51) Int. Cl. G01B 21/00; G01B 21/22

(52) U.S. Cl. 73/866.1; 702/151

(57) ABSTRACT

An integrated sensor system is provided capable of measuring both angular position and radial displacement of a member. The system includes a first sensor array for monitoring a displacement of the member. The monitored displacement of the member is used to calculate not only the angular position of the member but also any radial displacement at a first location on the member. Furthermore, the sensor system may be adapted to determine the tilt angle of the member by providing a second sensor array for monitoring a displacement of the member at a second location. The tilt angle may be determined by comparing the displacement of the member at the first location to the displacement at the second location.

### FIELD OF THE INVENTION

The present invention relates generally to sensors, and in particular to an integrated sensor system capable of measuring angular position, radial displacement, and tilt of a rotating member.

### BACKGROUND OF THE INVENTION

In mechanical, electromechanical, electromagnetic, optical, and other systems, motion is often initiated and controlled by actuation of a “rotational/translational member”. Often it is desirable to measure the angular, radial, tilt position, and time derivatives thereof of the member. There exists a variety of angular position sensors known to those skilled in the art for such tasks. Such sensor systems may be absolute or relative, and use either contacting or non-contacting sensing technology. Although numerous variations exist, the sensing system typically consists of a transmitter (often light), a quadrature detector and an encoded target. A non-contacting sensor system may utilize magnetic sensors, electromagnetic sensors, optically based sensors, etc. A contact sensor system may utilize potentiometers, surface acoustic wave, or other means. Radial position sensors may include gap sensors such as Hall effect sensors, capacitive sensors, eddy current sensors, etc. The output of such sensors may be used as input or feedback to a motion control system to monitor/control the position of the rotational/translational member, or the output of the sensor system may be used to perform measurements in metrology applications.

In addition to monitoring and measuring the angular position of the member 304 relative to the reference member 306 (see FIG. 3A and 3C), it is often desirable to monitor/measure the radial movement, i.e., run-out, or position of the member 304 relative to the reference member 306 (see FIG. 3B). In addition, the tilt angle of the member 304 relative to the member 306 may also be required (see FIG. 3D). Monitoring and measuring systems to produce such data may be contacting or non-contacting and may utilize fiber optic, eddy current, capacitance, Hall Effect, electromagnetic, etc. sensors.

Where the need to sense radial movement and angular position of a rotational/translational member 304 (see FIGS. 3B, 3C) are desired, two separate sensing systems and two or more separate feedback systems are typically utilized. Accordingly, there is a need in the art for an alternative apparatus/system that may simultaneously measure angular position and radial displacement with one integrated sensing system. Such a system may also be modified to simultaneously measure tilt angle as well. By suitably comparing the angular outputs of the two sensing systems torsion direction deflection may be also simultaneously detected. Such an apparatus may be utilized with multiple sensing elements in multivariate control problems such as those experienced with magnetic bearing control systems, or when performing complex meteorology of shaft properties.

### SUMMARY

According to a first embodiment, the present invention is an integrated sensor system for measuring simultaneous angular position and radial displacement of a sensed member, the system including a first sensor array having at least two sensors adjacent the sensed member, with each of the sensors adapted to monitor a displacement of the sensed member thus providing an output corresponding to the displacement of the sensed member. The sensor system further includes a processor configured to receive the output of each of the sensors and calculate the angular position and/or radial displacement of the sensed member adjacent the first sensor array based on the outputs of the sensors.

Consistent with the first embodiment, the invention may additionally include a second sensor array including at least two sensors adjacent the sensed member, with each of the sensors adapted to also monitor a displacement of the sensed member adjacent to the second sensor array and to provide an output corresponding to a displacement of the sensed member. The processor may be further configured to receive the outputs of the sensors of the second array and calculate an improved accuracy angular position, torsional displacement, and any tilt angle of the sensed member based on the radial and/or angular displacement of the sensed member adjacent the first sensor array and the radial displacement adjacent the second sensor array.

According to an alternative embodiment, the preset invention is an integrated sensor system for measuring angular position and radial displacement of a sensed member, the system including a first target scale disposed on the sensed member and a first sensor array including four sensors positioned equally spaced around the sensed member. Each of the sensors is adapted to sense a displacement of the first scale and output a first corresponding position signal. The sensor system also includes a processor responsive to the output of each sensor and adapted to calculate an angular position and radial displacement of the sensed member adjacent the first scale from the output. The number of sensing elements in this embodiment may provide cancellation of thermal differential expansion, as well as enable the system to operate despite a sensor failure, thus providing fault tolerance.

This second embodiment of the invention may further include a second scale disposed on the sensed member axially displaced from the first scale, and a second sensor array including four sensors positioned equally spaced around the sensed member, with the second sensor array being adapted to sense a displacement of the second scale and output a second corresponding position signal. The processor may be responsive to the output of the sensors of the second sensor array, and adapted to calculate a more accurate angular position as well as a tilt angle of the sensed member based on a position of the sensed member adjacent the first sensor array and a position adjacent the second sensor array. This two sensor array system can also measure torsion twist in the member coupling the two sensor arrays together by comparing an angular position of the sensed member adjacent each sensor array.

In method form, the present invention is a method for measuring angular position and radial displacement of a sensed member including providing a first sensor array including at least two sensors adjacent the sensed member, monitoring a displacement of the sensed member via the first sensor array, and outputting a signal from each of the sensors corresponding to the displacement of the sensed member. Finally, the method includes calculating an angular position and/or a radial position of the sensed member based on the outputted signals from each of the sensors of the first sensor array.

The method of the present invention may also include providing a second sensor array including at least two sensors adjacent the sensed member, monitoring a displacement of the sensed member adjacent the second sensor array via the second sensor array, and outputting a signal from each of the sensors of the second sensor array corresponding to the displacement of the sensed member adjacent the second sensor array. The additional output of the displacement of the sensed member adjacent the second sensor array may allow calculation of twist or torsion in the sensed member based on the angular difference between the two sensor systems outputs. Furthermore, a tilt angle of the sensed member may be provided based on the outputted signal corresponding to the displacement of the sensed member adjacent to the first sensor array and the displacement of the sensed member adjacent to the second sensor array.

According to yet another embodiment, the present invention is a method of determining a tilt angle of a sensed member including providing a first sensor array adjacent a first region of the sensed member, and monitoring a displacement of the first region of the sensed member via the first sensor array. The method also includes providing a second sensor array adjacent a second region of the sensed member and monitoring a displacement of the second region of the sensed member via the second sensor array. The tilt angle of the sensed member is determined by comparing the displacement of the first region of the sensed member to the displacement of the second region of the sensed member.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a simplified block diagram of a control system using angular and radial feedback from a sensor system consistent with the present invention;

FIG. 2 is a plan view of one embodiment of an angular position and radial displacement sensor system consistent with the present invention utilizing four sensors;

FIG. 3A illustrates a nominal position of a cylindrical member to be sensed by a sensor system consistent with the present invention;

FIG. 3B illustrates radial displacement of a cylindrical member to be sensed by a sensor system consistent with the present invention;

FIG. 3C illustrates rotational movement of a cylindrical member to be sensed by a sensor system consistent with the present invention;

FIG. 3D illustrates a tilt angle of a cylindrical member that may be sensed by a sensor system consistent with the present invention as detailed in the embodiment of FIG. 4; and

FIG. 4 is a simplified block diagram of another embodiment of the present invention for sensing angular position, radial displacement, and the tilt angle of a rotating cylindrical member including one possible sensor data processing system.

### DETAILED DESCRIPTION

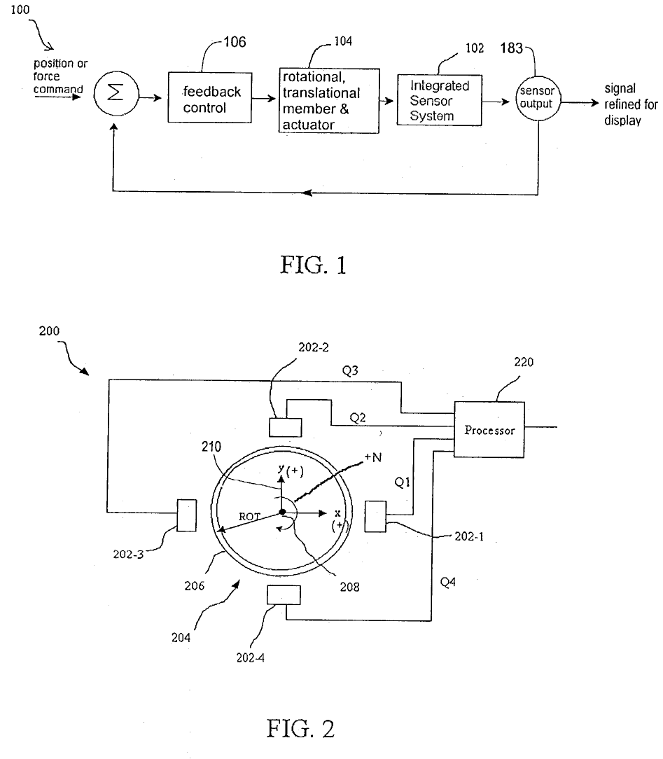

FIG. 1 is a simplified block diagram of a control system 100 capable of monitoring and controlling angular position and radial displacement of a sensed member 104 (hereinafter simply referred to as “member”). A feed forward path of such a system 100 may include the member 104 and a sensor system 102 consistent with the present invention capable of monitoring angular position, radial displacement, tilt angle, and other characteristics of the member 104. The member 104 may also rotate. There are numerous types of members in numerous systems that may be utilized with a sensor system 102 consistent with the present invention.

For instance, the member 104 may be a rotating shaft to drive various devices in a mechanical or electromechanical system. The member 104 may be any various types of material. For example, the member 104 may be a permanent magnet rotor assembly for an integrated motor/electromagnetic bearing. The sensor system 102 may include a plurality of angular or linear position sensors, such as will be known to those having skill in the art.

The control system 100 may further include a feed back path having feedback control 106 responsive to the sensor system 102 to control operation of the member 104. The feedback control 106 may include a control algorithm responsive to the sensed conditions of the member 104. The feedback control 106 provides a control signal to control an actuator. The actuator, e.g., a motor in one instance, imparts mechanical torques or forces to the member. Those skilled in the art will recognize a variety of control systems 100 for utilizing a sensor system 102 consistent with the present invention. It is to be understood, therefore, that the general control system 100 and the embodiments described herein are described by way of illustration, not of limitation.

Turning to FIG. 2, an exemplary sensor system 200 consistent with the present invention is illustrated. In general, the sensor system 200 may include a plurality of sensors 202-1, 202-2, 202-3, and 202-4 coupled to a processing means, e.g., processor 220 to monitor at least the angular position and/or radial displacement in the x-y plane of a member 204 to which a target or scale 206 may be affixed. The processor 220 may serve to power some sensors and process output from the sensors 202-1, 202-2, 202-3, and 202-4. The illustrated embodiment of FIG. 2 illustrates four sensors 202-1, 202-2, 202-3, and 202-4 although two or more sensors may be utilized in other embodiments.

The sensors 202-1, 202-2, 202-3, and 202-4 and the scale 206 may be a variety of devices that may, in general, monitor movement of the circumference of the member relative to the sensor. Preferably, the sensor/scale may operate in a non-contact fashion, e.g., using fiber optics, eddy currents, back EMF of a cooperating electromagnetic system, optical tape, capacitance, Hall Effect sensors, magnetic and electromagnetic, or some other non-contacting means to gather linear position or angular displacement data known to those skilled in the art. Absolute encoder sensing technology is preferred due to simplicity, although incremental encoder sensing technology when coupled with an adequate index or home position indicator will work. The incremental system could potentially provide a higher resolution.

In one exemplary embodiment, the Sensors 202-1, 202-2, 202-3, and 202-4 may be optical read heads and the scale 206 may be a linearly graduated tape scale affixed to the member 204 that cooperates with the read head based on a reflective operation. In operation, the member 204 rotates relative to a reference position, e.g., position 210 aligned with the positive y-axis. Accordingly, the linear tape gradated scale affixed to the member 204 also rotates. Each sensor 202-1, 202-2, 202-3, and 202-4, or read head in this instance, reads an N number of units relative to the member's position compared to the reference point. If a read head reads an increase of a number of N units, then the member 204 has moved in a clockwise direction relative to the reference position. Similarly, if a read head reads a decrease of a number of N units, then the member 204 has moved in a counterclockwise direction relative to the same reference position.

An angular positioning signal Q1, Q2, Q3, and Q4 may be simultaneously gathered or sampled and then provided to the processor 220 from each associated sensor 202-1, 202-2, 202-3, and 202-4. Knowing the number of units N the scale has traveled relative to a sensor 202-1, 202-2, 202-3, and 202-4, the processor 220 may calculate the position of the member 204 along the arc of the circle as appreciated by those skilled in the art. Hence, the number of N units traveled by the rotating member 204 may be translated into an angular or rotational position and a radial position as well. One process is to take the average of the sensor readings for the angular position. A radial position can be derived from the difference of each sensor reading as compared to the average.

As an example, a 100-micron pitch scale may have one gradation per 100 microns of length along the scale. Where the scale is optical tape affixed to the outside diameter of a cylindrical member, the tape may be of sufficient width to advantageously permit the sensor system to function in the presence of axial motion of the member. The sensors or the processor 220 may also include multiplying electronics to increase the resolution of the sensor system 200. Accordingly, each sensor by itself 202-1, 202-2, 202-3, or 202-4 is sampled to obtain an angular positioning signal that may be utilized by the processor 220 to calculate the true angular position of the member 204. Alternatively, two sensor systems may be utilized to provide angular positioning data to the processor 220, wherein the processor may take an average of two or more sensor systems to improve the accuracy of the angular result.

In addition to determining an angular position (or angular displacement) of the member 204, an exemplary sensor system 200 consistent with the present invention may advantageously also determine radial displacement of the member 204 in the x-direction, y-direction or any combination thereof.

In a constrained system, capable of radial movement only along a sing line, radial movement, in the presence of rotation, only two sensors would be necessary to monitor radial movement and rotation. For instance, if radial movement of the member 204 only in the x-direction were of interest, only the second sensor 202-2 and the fourth sensor 202-4 would be needed. This is because the first sensor 202-1 and the third sensor 202-3 would not sense any change of a member 204 that moved only in the x-direction. Similarly, only the first sensor 202-1 and the third sensor 202-3 would be necessary if only radial movement in the y-direction were of interest.

Typically, radial movement in both the x-direction and y-direction may be of interest as well as angular position/movement information. In order to obtain complete information about radial displacement and rotation, three sensors are required. The sensors are spaced around the member 204, preferably with each sensor equally spaced from the others according to an advantageous embodiment. Three sensors represent the minimum configuration necessary to perform simultaneous radial movement and angular position measurements. The math is more involved and the processing requirements are accordingly more involved when only three sensors are utilized, hence an exemplary embodiment is explained herein having four sensors with reference to FIG. 2.

Turning to FIG. 2, an exemplary sensor system 200 embodiment with four sensors 202-1, 202-3, 202-3, and 202-4 is illustrated. Advantageously, a four sensor system can continue operation in the presence of a single sensor failure with the accuracy of the system being only slightly degraded. In the embodiment of FIG. 2, if the member 204 with the attached scale 206 were to move only in the x-direction, the second sensor 202-2 and the fourth sensor 202-4 would observe a change in position equal in magnitude but opposite in direction. The first sensor 202-1 and the third sensor 202-3 would not observe any change. Similarly, if the member were to move only in the y-direction, the first sensor 202-1 and the third sensor 202-3 would observe a change in position equal in magnitude but opposite in direction. The second sensor 202-2 and the fourth sensors 202-4 would not observe any change.

The combination of all four sensors 202-1, 202-2, 202-3 and 202-4 is capable of measuring radial displacement in the x-direction and y-direction, in addition to measuring the angular position as earlier described. Advantageously, the radial displacement measurements may be made in conjunction or simultaneously-with the angular position measurement.

In operation, if one sensor, e.g., the fist sensor 202-1, read an increase in count of M units and the opposing sensor, e.g., the third sensor 202-3, read a decrease in count of M units, it would suggest a radial movement equal to M units in the negative y-direction, not a rotation movement. Alternatively, if the first sensor 202-1 and the third sensor 202-3 both read an increase of N counts, it could be deduced that there was a rotational movement of the member 204 and the angular position of the member 204 relative to a reference position would be N counts. In other words, the member 204 would have rotated through an angle defined by the scale 206 of N counts.

Advantageously, through the application of three or more sensors the radial displacement and angular position measurement may be made in conjunction with each other. In operation therefore, if the first sensor 202-1 read an increase of N+M counts and the third sensor 202-3 read an increase of N-M counts, a combination of rotational movement and radial movement could be determined. As before, the rotational movement would be equal to a distance of N counts along the arc defined by the scale 206 on the rotating member 204. The radial displacement would be M units in the positive y-direction. Accordingly, by applying these principles to the four sensors 202-1, 202-2, 202-3, and 202-4 any combination of radial displacement in x-direction, y-direction, or rotational movement of the member 204 may be determined.

Consistent with the exemplary embodiment, the several sensors 202-1, 202-2, 202-3, and 202-4 are positioned orthogonal and coplanar to each other on a plane that is normal to the axis of rotation 208 of the rotating member 204. This configuration is not necessary; however it may require the least complicated calculations to determine the rotation and translation of the member 204. Accordingly, the positioning of the sensors relative to each other and to the sensed member may be adjusted to suit individual applications. In an exemplary application of a magnetically suspended bearing system, the sensors may be arranged such that the radial gap sensing direction is aligned to the magnetic bearing force production axis to minimize coordinate transformation overhead.

Those skilled in the art will recognize that the optimum angular spacing of the sensors in the array is dependent on the number of sensors as well as the type of transformation used to convert the linear displacement to a displacement angle and a radial gap. For example a system using three sensors equally distributed around the moving member provides a relative displacement along the circumference. The displacement angle is the average of all sensor outputs, and the radial gap is the vector sum of the difference between each sensor output and the average sensor position. Those skilled in the art will also recognize alternatives and variations of these calculations that provide improved sensor resolution, or configurations that ease calculation burden.

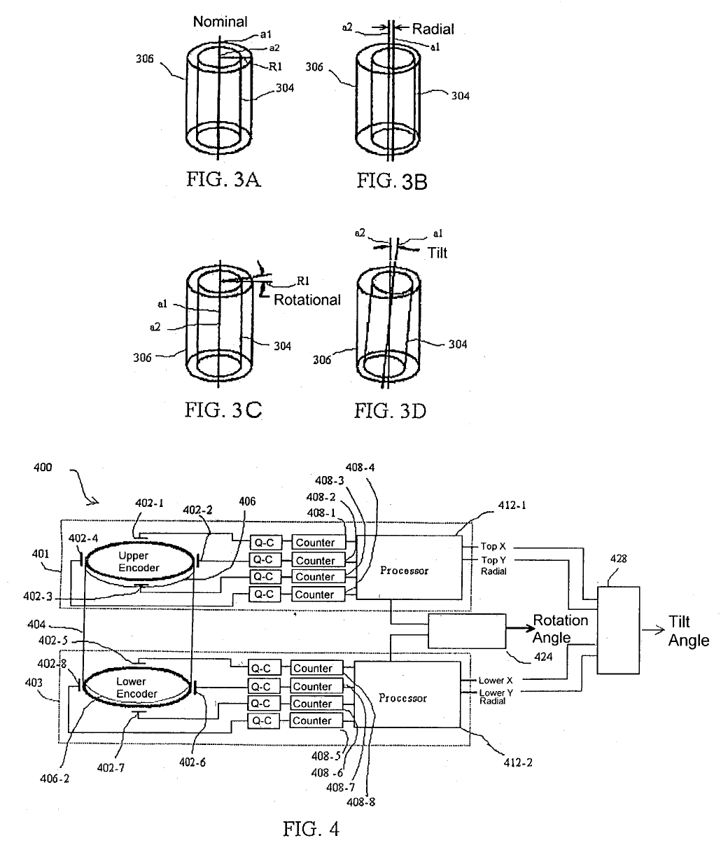

In addition, two or more sensor systems consistent with the present, invention may be utilized to simultaneously determine the angular position, radial movement, and tilt angle of a cylindrical member. This is because knowing the x and y-direction radial gap position or displacement of a member at two spaced apart positions of the axis of the member permits the tilt angle of the member to be calculated. The tilt angle is the angle defined by the rotational axis a1 of a cylindrical member 304 and the axis a2 of a reference cylinder 306 as illustrated in FIG. 3D. The two sensor systems need not be identical, e.g., the upper system may utilize four sensors while the lower system may utilize three sensors.

In comparison, FIG. 3A illustrates a nominal or reference position of a cylindrical member 304 centered inside a reference cylinder 306. In the nominal position, the rotational axis a1 of the rotating member 304 and the center axis a2 of the reference cylinder 306 coincide. As illustrated in FIG. 3C, the axis a1 of the rotating member 304 and the axis a2 of reference cylinder 306 still coincide, but the member 304 has rotated an angle relative to a reference position R1. As earlier detailed with reference to FIG. 2, a sensor system 200 consistent with the present invention may sense a distance d1 along the arc defined by the scale affixed to the member 304.

Turning to FIG. 3B, a radial displacement of the member 304 is illustrated. Any movement of the member 304 such that the axis a1 of the member 304 and the axis a2 of the reference cylinder 306 remain parallel but are at a distance from one another is considered to be in the radial direction. Finally, as earlier detailed, FIG. 3D illustrates the tilt angle of the rotating member. In one exemplary embodiment an optical tape is applied to the outside diameter of the cylindrical member, with lines aligned to the axis of the cylinder, to facilitate operation in the presence of axial motion. In this instance, one gap sensor can be integrated into the sensor system to detect axial motion.

While not directly illustrated in FIGS. 3A-3D, the system may also simultaneously determine torsion or twist of the member, in conjunction to rotational position, radial displacement, and tilt. Torsion of the member may be calculated as the difference in the rotational position between the first sensor system, or array, and the second sensor system, or array. Utilizing this system both dynamic torsion, torsion experienced during rotation of the member, and static torsion, torsion remaining after rotation of the member has stopped, may be measured.

Turning to FIG. 4, an exemplary embodiment of a combined sensor system 400 for sensing angular position, radial displacement, and tilt direction is provided. This described embodiment has four sensors in each sensor system 401, 403 for consistency of explanation with FIG. 2. As earlier detailed, each sensor system 401, 403 may have a variety of sensor configurations. A sensor system configuration for sensing angular position radial displacement, and tilt direction concurrently in a ridged system, includes a first sensor system with three sensors spaced apart from each other, preferably equidistant or 120 degrees, and a second sensor system with two sensors spaced 90 degrees from each other. A sensor system configuration for sensing angular position radial displacement, and tilt direction concurrently in a non-ridged system, includes a first sensor system with three sensors spaced equidistant or 120 degrees from each other, and a second sensor system with three sensors spaced equidistant or 120 degrees from each other.

The rotational/radial/tilt sensor system 400 of FIG. 4 may be used to provide position information to a feedback control system to control the rotational, radial, and tilt directions individually or simultaneously with fault tolerance, as a failure of one sensor from each system 401, 403 would not cause catastrophic sensor system failure. As illustrated, the rotational/radial/tilt sensor system 400 may include a first sensor system 401 at the upper portion of the cylindrical member 404 and a second sensor system 403 at the lower portion of the cylindrical member 404. Operation of the first 401 and second sensor systems 403 may be similar to the previously described embodiment of FIG. 2.

Accordingly, the first sensor system 401 includes four sensors 402-1, 402-2, 402-3, and 402-4 responsive to a first scale 406-1 affixed to the outer circumference of an upper portion of the cylindrical member 404. The four sensors 402-1, 402-2, 402-3, and 402-4 provide positioning signals, which are counted by associated counters 408-1, 408-2, 408-3, and 408-4. The counters are sampled to provide concurrent count data to the first processor 412-1.

As earlier detailed with reference to FIG. 2, the radial position of the upper portion of the cylinder 404 in the x-direction may be determined from the difference in M counts of the first sensor 402-1 and the third sensor 402-3. Similarly, the radial position of the upper portion of the cylinder 404 in the y-direction may be determined from the difference in M counts of the second sensors 402-2 and the fourth sensor 402-4. In addition, the rotational position may be determined from the number of N counts from each sensor individually or, the average angular position of the top portion of the member 404 may be determined by taking the average angular position provided by each sensor 402-1, 402-2, 402-3, and 402-4.

Similarly, the second sensor system 403 includes four sensors 402-5, 402-6, 402-7, and 402-8 responsive to a second scale 406-2 affixed to the outer circumference of the lower portion of the cylindrical member 404. Operation of the second sensor system 403 utilizing its processor 412-2 is similar to the first sensor system 401 and hence operational details are omitted herein.

An averaging device 424 may then take the average of the angular position data from the first sensor system 401, or Qtop average, and from the second sensor system 403, Qlower average, to provide a total average angular position Qave, for the entire system. This helps to reduce noise. Alternatively the processor could use the sampled sensor outputs in a fashion to obtain a higher effective resolution at the expense of higher system noise. Alternatively, this functionality could be provided within a single processor for the entire system 400.

In addition, the first sensor system 401 may provide Top X and Top Y radial position information. Similarly, the second sensor system 403 may provide Lower X and Lower Y radial position information. All sensor position information may be sampled to avoid errors due to latency in the information. This information may be further input into a tilt angle calculator 428 for calculating the tilt angle of the cylindrical member 404 relative to a reference position. Those skilled in the art will recognize a variety of devices, e.g., hardware or software, for making this tilt angle calculation by applying trigonometric identities. Alternatively, a single processing unit may provide the tilt angle calculator 428, the first processor 412-1, the second processor 412-2, and the averaging device 424 functions.

Accordingly, a rotational/radial/tilt sensor system 400 consistent with the present invention having a plurality of sensing systems 401, 403 along the axis of a rotating cylindrical member 404 may provide angular position, radial displacement, and tilt angle measurements for the member 404. Similarly torsion or twist of the member 404 may be calculated by comparing detected angular position at the respective sensing systems 401, 403. This sensed information may be used in any number of ways including a feedback control system to monitor and control the rotational, radial, and tilt directions and degree of torsion of the member 404 individually or simultaneously.

An exemplary use of a sensor system 400 consistent with the invention allows control and monitoring of the rotational angle, upper radial positioning (gap), lower radial positioning (gap) in the presence of vibration in all axis. An axial gap sensor is also integrated with the above sensor system as this system is fully and freely suspended magnetically. Typical specifications include:

Rotation to 200 rpm, position to 0.001°

Vertical excursion +/−0.025″

x-y positioning (top/bottom independent) +/−0.020″

Those skilled in the art will recognize that more than two sensing systems consistent with the present invention may be disposed along a member to control or measure aspects of critical speeds, modal vibrations, torsion stress concentration, or to provide enhanced accuracy of the sensed parameters. Additionally, it should be appreciated that the sensing system can also be inverted, whereby the member to be sensed is on the outside, and the sensors are deployed along the inside. Similarly, the member may comprise the stationary component with the sensor array comprising the rotating and/or tilting component.

The embodiments that have been described herein, however, are but some of the several which utilize this invention and are set forth here by way of illustration but not of limitation. It is obvious that many other embodiments, which will be readily apparent to those skilled in the art, may be made without departing materially from the spirit and scope of the invention.

What is claimed is:

1. An integrated sensor system for measuring angular position and radial displacement of a sensed member, the system comprising:
a first sensor array comprising at least two sensors adjacent to said sensed member, each of said sensors adapted to monitor a displacement of said sensed member and to provide an output corresponding to said displacement of said sensed member; and
a processor configured to receive said output of each of said sensors and calculating an angular position and a radial displacement of said sensed member adjacent said first sensor array based on said outputs of said sensors.

2. The integrated sensor system according to claim 1 comprising at least three sensors each providing an output to said processor.

3. The integrated sensor system according to claim 2 wherein said at least three sensors are coplanar to each other on a plane that is normal to an axis of rotation of said sensed member.

4. The integrated sensor system according to claim 1 wherein said sensors comprise non-contact sensors.

5. The integrated sensor system according to claim 4 wherein said non-contact sensors are selected from the group consisting of eddy current sensors, optical sensors, capacitance sensors, magneto-resistive sensors, Hall Effect sensors, and electro magnetic sensors.

6. The integrated sensor system according to claim 1 further comprising:
a second sensor array comprising at least two sensors adjacent to said sensed member, each of said sensors adapted to monitor a displacement of said sensed member and to provide an output corresponding to said displacement of said sensed member; and
wherein said processor is further configured to receive said outputs of said sensors of said second array and determine at least a radial displacement of said sensed member adjacent said second sensor array, and calculate a tilt angle of said sensed member based on said radial displacement of said sensed member adjacent said first sensor array and said radial displacement adjacent said second sensor array.

7. The integrated sensor system according to claim 1 wherein said processor is further configured to calculate a torsion of said sensed member based on said angular position of said sensed member adjacent said first sensor array and an angular position of said sensed member adjacent said second sensor array.

8. An integrated sensor system for measuring angular position and radial displacement of a sensed member, the system comprising:
a first scale disposed on said sensed member;
a first sensor array comprising four sensors positioned equally spaced around said sensed member, each said sensor adapted to sense a displacement of said first scale and output a first corresponding position signal;
a processor responsive to said output of each sensor, and adapted to determine an angular position and radial displacement of said sensed member adjacent said first scale from said output.

9 An integrated sensor system according to claim 8 further comprising:
a second scale disposed on said sensed member axially displaced from said first scale; and
a second sensor array comprising four sensors positioned equally spaced around said sensed member, said second sensor array adapted to sense a displacement of said second scale and output a second corresponding position signal;
wherein said processor is further responsive to said output of said sensors of said second sensor array, and adapted to calculate a tilt angle of said sensed member based on said displacement adjacent said first sensor array and said displacement adjacent said second sensor array.

10. An integrated sensor system according to claim 8, wherein said fist scale comprises a linear scale and said sensors of said first sensor array are configured to determine a linear displacement of said linear scale.

11. An integrated sensor system according to claim 8 wherein said linear scale comprises an optical linear scale and said sensors of said first sensor array comprise optical read heads.

12. An integrated sensor system according to claim 9 wherein said second scale comprises a linear scale and said sensors of said second array are configured to determine a linear displacement of said linear scale.

13. An integrated sensor system according to claim 12 wherein said linear scale comprises an optical linear scale and said sensors of said first sensor array comprise optical read heads.

13. An integrated sensor system according to claim 9 wherein said processor is further adapted to calculate a torsion of said sensed member based on said angular position adjacent said first scale and an angular position adjacent said second scale.

14. A method for measuring angular position and radial displacement of a sensed member comprising:
providing a first sensor array comprising at least two sensors adjacent to said sensed member;
monitoring a displacement of said sensed member via said first sensor array;
outputting a signal from each of said sensors corresponding to said displacement of said sensed member; and
determining an angular position and/or a radial displacement of said sensed member based on said outputted signals from each of said sensors of said first sensor array.

15. The method according to claim 14 wherein said first sensor array comprises at least three sensors.

16. The method according to claim 15 wherein said at least three sensors are coplanar to each other on a plane that is normal to an axis of rotation of said sensed member.

17. The method according to claim 14 wherein said sensors comprise non-contact sensors selected form the group consisting of: eddy current sensors, optical sensors, capacitance sensors, Hall Effect sensors, and electromagnetic sensors.

18. The method according to claim 14 further comprising:
providing a second sensor array comprising at least two sensors adjacent to said sensed member;
monitoring a displacement of sensed member adjacent to said second sensor array via said second sensor array;
outputting a signal from each of the sensors of said second sensor array corresponding to said displacement of said sensed member adjacent to said second sensor array; and
calculating a tilt angle of said sensed member based on at least said outputted signal corresponding to said displacement of said sensed member adjacent to said first sensor array and said displacement of said sensed member adjacent to said second sensor array.

19. A method of determining a tilt angle of a sensed member comprising;
providing a first sensor array adjacent to a first region of said sensed member;
monitoring a displacement of said first region of said sensed member via said first sensor array;
providing a second sensor array adjacent to a second region of said sensed member;
monitoring a displacement of said second region of said sensed member via said second sensor array;
comparing said displacement of said first region of said sensed member to said displacement of said second region of said sensed member.
